(19) United States
(12) Patent Application Publication
(10) Pub. No.: US 2026/0254812 A1
(43) Pub. Date: Aug. 27, 2026

(54) SYSTEMS AND METHODS FOR REAL TIME AUTHENTICATION OF COMMUNICATIONS

(71) Applicant: Synchrony Bank, Stamford, CT (US)

(72) Inventors: David Chau, Stamford, CT (US); Amit Birla, Stamford, CT (US); Casey Wheeler, Stamford, CT (US); Tarun Saha, Stamford, CT (US); Eswar Mamidi, Stamford, CT (US); Richard Carrasco, Stamford, CT (US); Venkataramakrishna Narukulla, Stamford, CT (US)

(21) Appl. No.: 19/064,038

(22) Filed: Feb. 26, 2025

(51) Int. Cl. H04L 9/40

(52) U.S. Cl. CPC H04L 63/0876

(57) ABSTRACT

An authentication system identifies patterns of access request to a network to limit access to the network by malicious devices. Upon receiving an access request, the authentication system attempts to insert a first feature of an access request in a first table. If an error occurs, the authentication system attempts to insert two or more features of the access request into a second table. If the insertion does not cause an error, the authentication system queries the second table using the first feature. Upon detecting that the number of entries of the second table associated with the first feature is great than a threshold, the authentication system terminates access to network by devices associated with the first feature.

### TECHNICAL FIELD

This disclosure relates generally to authenticating communications, and more particularly to authenticating communications between two or more devices in real time.

### BACKGROUND

Restricted devices and/or resources use a variety of authentication techniques to control access to sensitive information or resources. Authentication techniques are often selected to balance the complexity of the authentication techniques to a requesting user or device and the degree of security to be provided. For example, the authentication techniques can include determining an identity of a requesting user and/or device, access credentials, public/private key encryption, tokens, two-factor authentication, etc. Some devices with sensitive information may use multiple authentication techniques such as access credentials and two-factor authentication. Devices that control access to less sensitive information may rely on just access credentials or characteristics of the requesting device (e.g., such as an Internet Protocol (IP) address, etc.).

### SUMMARY

Methods are described herein for real-time authentication of access requests to secured resources. The methods may include receiving an authentication request associated with a client device, wherein the authentication request includes information derived from a communication session between a user device and the client device; executing a first storage operation to insert a portion of the information into a first database table; detecting a first exception in response to executing the first storage operation, wherein detecting the first exception indicates a presence of the information in the first database table; and transmitting a communication to the client device, wherein upon being received, the communication causes the client device to terminate the communication session with the user device

The systems described herein for real-time authentication of access requests to secured resources. The systems may include one or more processors and a non-transitory computer-readable medium storing instructions that, when executed by the one or more processors, cause the one or more processors to perform any of the methods as previously described.

The non-transitory computer-readable media described herein may store instructions which, when executed by one or more processors, cause the one or more processors to perform any of the methods as previously described.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 illustrates a block diagram of example authentication system configured to process access requests for resources of a network according to aspects of the present disclosure.

FIG. 2 illustrate an example interface configured to manage storage operations within databases tables according to aspects of the present disclosure.

FIG. 3 illustrates an example flowchart to detect fraudulent access requests according to aspects of the present disclosure.

FIG. 4 illustrates a flowchart of an example process for authentication of access requests to secured resources according to aspects of the present disclosure.

FIG. 5 illustrates an example computing device architecture of an example computing device that can implement the various techniques described herein according to aspects of the present disclosure.

### DETAILED DESCRIPTION

Method and systems are described herein for authentication of access requests to secured resources. Malicious devices and/or the users thereof may exploit information associated with user devices and/or the users thereof to gain unauthorized access to resources secured by a network. The network may include authentication features that detect and prevent such access. In some examples, the network may secure access to resources available to users. When a user requests access to resources of the network, the user may provide access credentials and/or a token associated with a user profile to authenticate the user and/or the user device. In some instances, a client device or operator may request access to the network on behalf of the user. For instance, a user may use other devices when requesting access to the resources of the network such as a terminal device associated with a client device providing objects or services to user devices and/or the users thereof. The user may provide information to the terminal device that enables access to the resources in exchange for the objects or services provided to the user device and/or the user.

Malicious devices may exploit this arrangement by impersonating the user device and/or the user thereof. For example, a malicious device may obtain network access information associated with a user device and/or the user thereof (e.g., access credentials, tokens, personal identifiable information, etc.). The malicious device may then impersonate the user device and/or the user thereof to a terminal device. The process for authenticating resource access requests is very fast due an expectation that resources access requests are resolved while a user device is proximate to a terminal device. Malicious devices may attempt to overwhelm the security provided by networks by generating multiple resource access requests at the same time or within short time window. The multiple resource access requests may be associated with multiple different user device and/or users. Since the network attempts to resolve resource access requests quickly, the malicious device hope that such large quantities of near-simultaneous resource access requests will force the network to review the resource access request with less scrutiny and causing at least some of the multiple resources access requests to be granted by the network.

Networks may include authentication features that detect and prevent attempts to impersonate user devices and/or the users thereof. In some examples, networks may use pattern recognition techniques to identify one or more fraudulent resource access requests such as those generated by a malicious device. Networks may store communications associated with resource allocation requests using a table. The table may include additional information such as information associated with a terminal device and/or client device that transmitted the communication, information associated with a location of the terminal device, a quantity of resources requested, etc. The network may compare each new communication to the communications in the table to determine if characteristics of the new communication match any of the characteristics of the previous communications. If, for example, multiple resource allocation requests are associated with a same origin location within a threshold time interval, then the resource allocation requests may be associated with a malicious device attempting to access the network and resources associated with multiple user devices and/or the users thereof. If the new communication does match a threshold quantity of communication within the threshold time interval, then authentication may be terminated. With large networks that receive many such communications each second, the time complexity of searching the table may grow causing each new communication to take longer to authenticate.

The methods and systems described herein include an authentication system that scales the authentication rate for access requests to secured resources for improved access authentication when managing high-volume access request. The authentication system includes a first table that stores an address included in each access request (e.g., such as, but not limited to, an Internet Protocol (IP) address of the user device that initiated the access request, a Media Access Control (MAC) address of the user device that initiated the access request, a mailing address of the user device that initiated the access request, an IP address of terminal device and/or client device that generates the access request for the user device, a MAC address of terminal device and/or client device that generates the access request for the user device, a mailing address of terminal device and/or client device that generates the access request for the user device, a mailing address associated with the user profile identifier identified by the access request, a mailing address associated with the user including the access request, etc.) and user profile identifier (e.g., an account managed by the network, etc.) included in each access request. The first table may be a relational table that stores information in key-value pairs with the address being the primary key and the user profile identifier as the value. Alternatively, the first table may store other information as the value such as, but not limited to, a timestamp associated with the access request, a value of the access request, a user profile identifier, user identifier, demographic information associated with the user, a transaction identifier, a random value, a token, a cryptographic key, a hash value, a null value, combinations thereof, and/or the like. Relational tables (e.g., relational database management system RDMBS tables, and/or the like) do not allow storing more than one primary key. The authentication system can exploit the primary key rule of the relational tables to identify duplicate access requests without having to search the table. For example, the authentication system attempts to insert a primary key (e.g., the address associated with the access request) and the corresponding value into the first table. If the first table accepts the insertion, then the authentication system determines that the primary key did not exist within the first table before the insertion. If the first table generates an exception (e.g., an error, etc.), then the authentication system determines that there is a previous instance of the primary key already stored within the first table. Thus, the authentication system can determine if a primary key exists without having to spend time searching the table for the primary key.

The authentication system may use the first table to identify multiple access requests that use the same address. In some examples, the authentication system may identify malicious devices by detecting multiple access requests originating from a same address. If a second access request associated with the same address is identified, the authentication system may deny the second access request and any subsequent access requests associated with the same address as the access requests likely correspond to a malicious device. While the authentication system may prevent malicious devices from accessing or further accessing the network, the authentication may also prevent a legitimate user from accessing the network multiple times (e.g., accessing resources for different terminal devices, client devices, etc.). In other examples, the authentication system may tolerate multiple access requests associated with a same user profile identifier or associated with multiple user profile identifiers that are each associated with a same user. In those examples, the authentication system may identify malicious devices that generate a predetermined frequency of access request and/or malicious devices that attempt to impersonate different users simultaneously (or within a predetermined temporal proximity). For example, the authentication system may identify malicious device by identifying multiple access requests originating from a same address associated with different user profile identifiers managed by the network.

The authentication system may use a second table that also stores the address and user profile information associated with an access request. The second table may be a relational table (e.g., a RDBMS, etc.) that stores information in key/value pairs. If the authentication system detects that the primary key (e.g., the address, etc.) of an access request is already within the first table, the authentication system may generate a second primary key using the address associated with the access request and the user profile identifier associated with the access request. In some instances, the authentication system may concatenate the address and the user profile identifier. In other instances, the authentication system may use any other mechanism to generate a primary key from the address and user profile identifier (e.g., such as using hashing, etc.). The value may be a timestamp associated with the access request (e.g., when the access request was generated and/or when the access request was received, etc.). Alternatively, first table may store other information as the value such as, but not limited to, a value of the access request, user identifier, demo graphic information associated with the user, a transaction identifier, a random value, a token, a cryptographic key, a hash value, a null value, a quantity of instances the authentication system attempted to store the second primary key in the second table, combinations thereof, and/or the like. The value may be a single value or a tuple comprising one or more values.

The authentication may then insert the second primary key and the corresponding value in the second table. If the second primary key is inserted successfully (e.g., no error is generated), then the second primary key did not already exist in the second table (e.g., the second primary key is new). The authentication system records a frequency value in response to an indication that the second primary key was inserted in the second table. The frequency value may be initiated at two (as this is the second instance of an access request associated with the same address). In some examples, the frequency value is an integer stored as the value corresponding to the second primary key. In other instances, the frequency value is stored as an integer in another memory location (e.g., another table, data structure, etc.) in association with the address. If an error is generated when inserting the second primary key, then the authentication system determines that the second primary key was already inserted in the second table (and there are at least two instances of access requests involving the same address). The authentication system may then increment the frequency value associated with the address. If the frequency value is greater than a threshold, the authentication system may determine that it is likely that the access requests are associated with a malicious device and deny further access requests associated with the address.

Alternatively, or additionally, the authentication system may execute a query associated with the address (e.g., select count query, etc.) to determine the quantity of table entries within the second database table that include the same address. The query may be executed each time a second primary key error occurs, at regular time intervals (e.g., every hour, every 2 hours, etc.), each time there is an attempt to insert a second primary key, etc. Executing the query enables the authentication system to identify instances where the same address appears in association with different user profile identifiers (which would be associated with different second primary keys). The frequency value may be updated with the value returned by the query. In some examples, the authentication system may execute the query to determine the frequency value in place of storing the frequency value to reduce the memory usage of the authentication system.

Generally, malicious devices that acquire access credentials for a user profile or network maximize attempt to maximize access to the user profile or network before the access credentials are changed or the fraudulent access is detected. Thus, malicious devices are likely to generate multiple access requests within a short time interval. The authentication system may use the first table and/or the second table to identify instances where a malicious device generates frequent access requests. If the frequency value associated with a particular address is greater than a threshold frequency value, then the authentication system may terminate access to the network by the malicious device, deactivate access credential associated with user profile, prevent subsequent access to the user profile, temporarily prevent access to the network, modify and/or distribute new cryptographic keys, modify and/or distribute new access credentials for the user profile and/or other user profiles, confirm an identity of the device generating the access requests, combinations thereof, and/or the like.

In some examples, the authentication system may prune the first table and/or the second table so that the tables store access request information related to a predetermined time window. For example, since malicious devices may be more likely to generate multiple access requests in a short time interval, the authentication system may remove older access request information (e.g., access request information outside the time window, etc.) so that the first table and/or the second table store “recent” information. The time window may be selected based on balancing the need to identify fraudulent access requests and preventing misclassifying legitimate access requests. For example, a longer time window may be associated with a higher likelihood of identifying fraudulent access requests but also associated with a higher likelihood of including false positives (e.g., classifying legitimate access requests as fraudulent, etc.). A shorter time window may be associated with a lower likelihood of identifying fraudulent access requests but also be associated with a lower likelihood of including false positives. In some instances, the time window may be predetermined and correspond to the last n hours (e.g., beginning at a current time and extending backwards n hours from the current time, etc.) where n may be any real number such as, but not limited to, 1 hour, 2 hours, 4 hours, etc.

In other instances, the authentication system may dynamically define the time window based on one or more factors such as an access request rate, a previous frequency of access requests associated with a same user profile identifier and/or address, time of day, country associated with an access request, value requested by the access request, user identifier, previous identification of malicious devices and/or fraudulent access requests, combinations thereof, and/or the like. For example, if a user regularly generates multiple access requests within the time window, the time window may be increased to prevent misclassifying legitimate access requests by the user. In some instances, the authentication system may use a dynamic time window that varies based on address, user profile identifier, and/or the like. For example, the authentication system may remove access request information associated with a first address that are older than 2 hours and remove access request information associated with a second address that are older than 3 hours. The authentication system may use pattern analysis algorithm to identify patterns of access requests associated with particular address, user profile identifier, and/or the like and define an individual time window for those particular addresses, user profile identifiers, and/or the like.

The pattern matching algorithm may be based on a statistical analysis of access requests. In some examples, the pattern matching algorithm may be implemented by a probabilistic classifier (e.g., a trained machine-learning model). The machine-learning model may include, but is not limited to, Naïve Bayes, logistic regression models, perceptrons, support vector machine, random forest models, linear discriminant analyses models, k-nearest neighbor, k-means clustering algorithms, fuzzy c-means (FCM), expectation-maximization (EM), hierarchical clustering, density-based spatial clustering of applications with noise (DBSCAN), boosting, decision trees, combinations thereof, and/or the like. The machine-learning model may be trained using supervised learning, unsupervised learning, semi-supervised learning, transfer learning, metalearning, reinforcement learning, combinations thereof, or the like. The machine-learning model may be trained for a predetermined time interval, predetermined quantity of iterations, and/or until one or more accuracy metrics are reached (e.g., such as, but not limited to, accuracy, precision, area under the curve, logarithmic loss, F1 score, mean square error, or the like, combinations thereof, and/or the like).

In an illustrative example, an authentication system may receive an access request associated with a client device, wherein the authentication request includes information derived from a communication session between a user device and the client device. The information derived from the communication session may include access credentials, an address associated with the user device and/or the client device, a time stamp associated with the access request, a user profile identifier associated with a user profile management by the authentication system, combinations therefore, and/or the like. For example, a user device may establish a communication session with a client device. The communication session may include real time communications (e.g., textual communications, voice communications, video communications, and/or the like) or asynchronous communications (e.g., non-real time, etc.). The communications may include natural language communications or data communications. In some examples, the communication session may be established over web-based interface such as a webpage, web application, etc.

For instance, a user device may connect to a webpage operated by the client device, hosted by the client device, associated with the client device, etc. The webpage may provide objects and/or services to the user device. The user device may establish a communication session requesting access to one or more objects and/or services and provide information associated with a user profile of to the user device (and/or the user thereof) such as, but not limited to, an address of the user device and/or the user thereof, a user profile (e.g., account) identifier, an identification of the one or more objects and/or services, combinations thereof, and/or the like. The user profile may be associated with a set of resources of the user that are managed by a network and the authentication system may control access to the network. The client device may receive the information associated with the user profile and execute an access request to the authentication system to access a resource corresponding to the user profile.

In some examples, the authentication system operates on historical access requests to prevent future access to the resources of the network. In those examples, the access requests may already be resolved by the network (e.g., granted or denied, etc.). The authentication system reviews the access requests to identify access requests that were likely associated with malicious devices and prevents subsequent access requests associated with the malicious devices and/or access requests that appear similar to the historical access requests that were classified as associated with malicious devices. For example, the authentication system may identify, and block future access requests associated with a same address as the access requests associated with the malicious devices. In other examples, the authentication system may operate on access requests before the access requests are resolved by the network. In those examples, each new access request may be reviewed by the authentication system based on current and historical access requests to determine if the access request should be granted or denied.

The authentication system may execute a first storage operation to insert a portion of the information into a first database table. The first database table may be a relational table (e.g., such as a RDBMS, etc.). The relational table may store data as key/value pairs where the key is referred to as a primary key. The primary key is unique and identifies a particular location within the first database table (e.g., such as a row within the first database table). Since the primary key is intended to be unique, the first database table may not tolerate duplicate primary keys. Instead, attempting to insert a duplicate primary key causes the first database to generate an error (e.g., also sometimes referred to as a primary key integrity violation, primary key exception, duplication key exception, etc.).

The authentication system may use the information to generate the primary key. For instance, the authentication system may define the primary key as the address associated with the access request (e.g., the address of the user device, the address of the user thereof, the address associated with the user profile, etc.). Alternatively, or additionally, the authentication system may define the primary key using, but not limited to, a timestamp associated with the access request (e.g., when the access request was generated and/or when the access request was received, etc.), a resource value requested by the access request, a user identifier, demographic information associated with the user, a transaction identifier, a random value, a token, a cryptographic key, a hash value, combinations thereof, and/or the like. The value to be stored in the database table corresponding to the primary key may include, but is not limited to, a timestamp associated with the access request (e.g., when the access request was generated and/or when the access request was received, etc.), a resource value requested by the access request, a user identifier, demographic information associated with the user, a transaction identifier, an identification of the client device, an address associated with the client device, a random value, a token, a cryptographic key, a hash value, a null value, any other information associated with the access request, combinations thereof, and/or the like.

The authentication system may exploit the primary key integrity error as a way of searching the first database table for the primary key while avoiding the processing time and/or resources to search the first database table, which increases the rate in which the authentication system can process resource requests. If the first storage operation terminates successfully (e.g., no errors are generated, etc.), then authentication system determines that this is the first instance of the primary key within the first database table and the first access request involving the portion of the information used to define the primary key (e.g., the address of the access request). If the first storage operation causes an error (e.g., such as any of the aforementioned errors), the authentication system determines that this is not the first instance of the primary key within the first database table and not the first access request involving the portion of the information used to define the primary key (e.g., the address of the access request).

In response to detecting the insertion error, the authentication system may transmit a communication to the client device. The communication, upon being received by the client device, may cause the client device to terminate the communication session with the user device, which may prevent the client device from accessing resources associated with the user profile identified in the access request.

Alternatively, the authentication system may define a second primary key and execute a second storage operation to insert the second primary key into a second database table. In some examples, the second primary key may be defined using the portion of the information used to define the first primary key and a second portion of the information. For instance, the second primary key may be defined from the address and a user profile identifier (e.g., an account identifier, etc.) of the user profile by, for example, concatenating the address and the user profile identifier, generating a hash value, and/or any other process for combining to data values. The second portion of the information may include, but not limited to, a user profile identifier, a timestamp associated with the access request (e.g., when the access request was generated and/or when the access request was received, etc.), a resource value requested by the access request, a user identifier, demographic information associated with the user, a transaction identifier, an identification of the client device, an address associated with the client device, a random value, a token, a cryptographic key, a hash value, any other information associated with the access request, combinations thereof, and/or the like. The value to be stored in the second database table corresponding to the second primary key may include, but is not limited to, a number of storage operations executed using the second primary key (e.g. storage operations that executed successfully or generated errors, etc.), a timestamp associated with the access request (e.g., when the access request was generated and/or when the access request was received, etc.), a resource value requested by the access request, a user identifier, demographic information associated with the user, a transaction identifier, an identification of the client device, an address associated with the client device, a random value, a token, a cryptographic key, a hash value, a null value, any other information associated with the access request, combinations thereof, and/or the like. For example, the value stored in association with the second primary key may be an indication of how many times the authentication system attempted to insert the second primary key into the second database table so as to track the number of access requests involving the same address and user profile identifier. Alternatively, the value stored in association with the second primary key may be a timestamp associated with the most recent access request involving the same address and user profile identifier.

If the second storage operation terminates successfully (e.g., no errors are generated, etc.), then authentication system determines that this is the first instances of the second primary key within the second database table and the second access request involving the portion of the information used to define the primary key (e.g., the address of the access request). If the second storage operation causes an error (e.g., such as any of the aforementioned errors), then the authentication system determines that this is not the first instances of the second primary key within the second database table and that there has been at least two previous access request involving the portion of the information used to define the primary key (e.g., the address of the access request).

If the second storage operation terminates successfully, the authentication system may execute a count query to identify the number of entries in the second database table associated with a same address and/or user profile identifier. Since each second primary key includes a combination of two or more values, it may be possible for the second database table to store entries with the same address but different user profile identifiers and entries with the same user profile identifiers but different addresses, etc. The count query may return an integer value corresponding to how many entries in the second database table include the same address and/or user profile identifier. If the integer value is greater than a threshold value, then the authentication system may deny access to the current access request being processed and prevent any subsequent access requests from the same address and/or user profile identifier.

The threshold value may be determined based on a quantity of acceptable access requests from a same address and/or user profile identifier within time a time interval. The threshold value may be any integer value such as, but not limited to, 2, 3, 4, etc.). The threshold value may be defined based on the length of the time interval with a longer time interval corresponding to a higher threshold value. Increasing the threshold value may increase the access to the resources of a user profile but also increase the potential impact to the user profile and/or network if a malicious device is attempting to access the network. Lowering the threshold value may reduce the potential impact to the user profile and/or network if a malicious device is attempting to access the network but also increase a likelihood that legitimate access requests get denied. The authentication system may define (or adjust) the threshold value balancing the impact and access of devices generating access requests. In some examples, the threshold value may be dynamically defined based a rate of new access requests, historical access requests, a particular address, a particular user profile identifier, a particular user device and/or user, an average value of access requests, a value of a particular access requests, administrator input, a particular client device, combinations thereof, and/or the like. For example, the threshold value may be increased for user devices that historically generate multiple access requests within the time interval or decreased for user devices that historically generate few access requests within the time interval.

The time interval may be statically defined (e.g., predefined, etc.) or dynamically defined (e.g., defined and/or adjusted in real time). In some examples, the authentication system may statically define the interval may be any real number such as, but not limited to, 30 minutes, 1 hour, 2 hours, etc. The authentication system may dynamically define (or adjust) the time interval value based on one or more factors such as, but not limited to a rate of new access requests, historical access requests, a particular address, a particular user profile identifier, a particular user device and/or user, administrator input, an average value of access requests, a value of a particular access requests, a particular client device, combinations thereof, and/or the like. Like the threshold value, modifying the time interval may also increase or decrease an impact a potential malicious device may have on a user profile and/or the network at the expensive of increasing or decreasing the possibility of false positives. For example, increasing the time interval may increase access to the resources of a user profile but also increase the potential impact to the user profile and/or network if a malicious device is attempting to access the network (e.g., the malicious device may generate more access requests before being detected, etc.). Lowering the time interval may reduce the potential impact to the user profile and/or network if a malicious device is attempting to access the network but also increase a likelihood that legitimate access requests get denied.

If the second storage operation terminates unsuccessfully and results in an error, then the authentication determines that the second primary key already exists within the second database table, then the authentication system may update the timestamp associated with the second primary key (e.g., the time corresponding to the last access request involving this account and user profile identifier, etc.). Updating the table ensures the second primary key remains in the second database table at least as long as the time interval.

The first database table and/or the second database may be cleaned to ensure only the most recent access requests are processed by the authentication system. In some examples, the first database table and/or the second database table may be cleaned in regular intervals defined based on the time interval. In other examples, the first database table and/or the second database table may be cleaned upon detecting an event such as upon processing a new access request, etc.

The authentication system may remove primary keys associated with timestamps older than the time interval. In some instances, the second database table may be cleaned before the first database table. The authentication system may determine if a second primary key of the second database table is older than the time interval and, if so, remove the second primary key from the second database table. The authentication system may then determine for each second primary key removed, if the address associated with the second primary key exists within another second primary key. If the address associated with the second primary key exists within another second primary key, then the authentication system moves on to the next second primary key being removed. If the address associated with the second primary key does not exist within another second primary key, then the authentication system processes the primary key corresponding to that address in the first database table. If the primary key corresponding to that address in the first database table is older than the time interval, then the primary key is removed from the first database table. If the primary key corresponding to that address in the first database table is not older than the time interval, then authentication system leaves the primary key in the first database table.

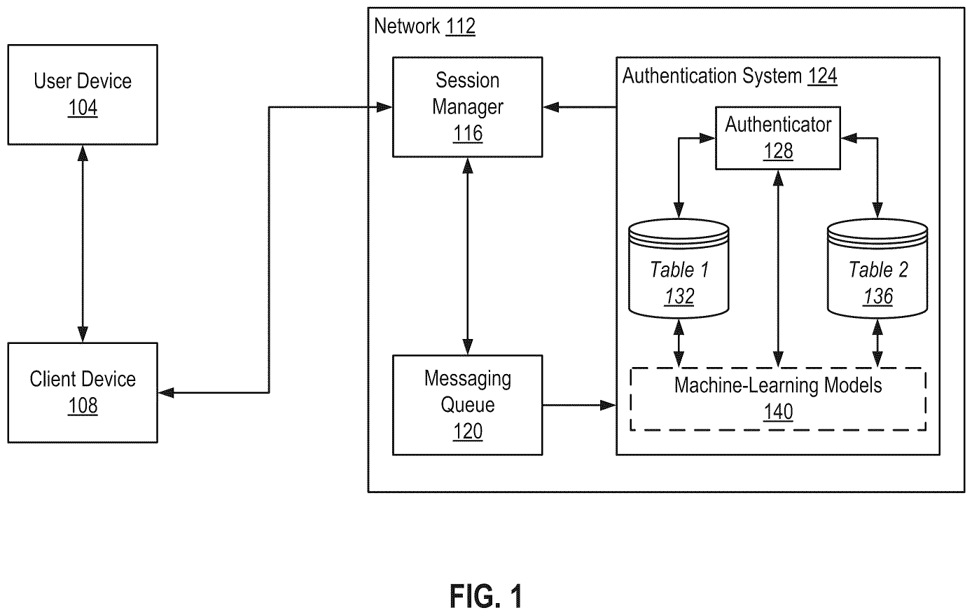

FIG. 1 illustrates a block diagram of example authentication system configured to process access requests for resources of a network according to aspects of the present disclosure. An authentication system may manage a communication session between a user device and a client device to facilitate a distribution of resources available to the user device and managed by a network. For instance, a user device 104 may establish a communication session with client device 108 to access objects and/or services provided by client device 108. In some examples, client device 108 may be an entity that operates a website or other network-addressable location that accepts connections from remote devices such as user device 104. In other examples, client device 108 may be a terminal device located proximate to the objects and/or provided services. User device 104 may generate an access request for resources of user device 104 (and/or the user thereof) that are managed by a network (e.g., such as network 112, etc.). The access request may be generated by client device 108 (or by a device associated with client device 108). The access request may include a user profile identifier (e.g., an account identifier associated with the resources of network), user information of a user of the user device, (e.g., such as, but not limited to, a user identifier, a username, access credentials, a physical address of the user, one or more electronic addresses associated with the user device and/or the user, an identification of objects and/or services requested, an identification of a value of resources being requested, an identification of client device 108, a physical address of the client device 108, one or more electronic addresses associated with the client device 108,, combinations thereof, and/or the like), a timestamp corresponding to when the access request was generated, combinations thereof, and/or the like.

Client device 108 may transmit the access request to network 112. Network 112 may include one or more devices configured to manage resources of user devices and/or the users thereof. The one or more devices may include computing devices, servers, databases, cloud networks, combinations thereof, and/or the like. In some examples, network 112 may be a centralized computing cluster. In other examples, network may be a distributed computing environment. Network 12 may include session manager 116, messaging queue 120 and authentication system 124. Session manager 116 may receive access requests to network 112 and establish a session between client device 108 and network 112. Session manager 116 may include some authentication protocols to ensure that the safety of client device 108, network 112, and/or the session. The authentication protocols may include, but not are not limited to, requesting access credentials (e.g., username and/or password, encryption keys, tokens, etc.) from client device 108, encrypting the session, determining an identity of client device 108 (e.g., matching hardware and/or software fingerprints of client device 108 to historical fingerprints, matching IP addresses to previous IP address from client device 108, matching MAC addresses to a known MAC address from client device 108, etc.). Upon authenticating client device 108, session manager 116 may pass the access request to messaging queue 120. Messaging queue 120 stores access requests in first-in-first-out data structure.

Authenticator 128 may be configured to identify malicious devices and/or fraudulent access requests (e.g., access requests from users that are not authorized to access resources associated with the user profile identifier of the access request), by identifying instances where a device generates multiple attempts to access network 112. Authentication system 124 may process access requests from messaging queue 120. Authenticator 128 may manage two database tables that store information on access requests received within a preceding time interval (e.g., the last n minutes, the last n hours, etc.). Table 1 132 and table 2 136 may store data using an index. A primary key may identify a location within the index that stores corresponding data. In some examples, table 1 132 and table 2 136 may be relational tables such as, but not limited to, RDBMS tables. When processing an access request the authenticator 128 defines a first primary key using information from the access request such as an address associated with user device 104 and/or the user thereof. The corresponding value to be inserted in associated with the primary key may be any information associated with access request, a null value, a random value, a transaction identifier, combinations thereof, and/or the like. In some examples, authenticator uses a timestamp associated with the access request as the value to be stored in table 1 132. Instead of searching table 1 132 for a corresponding primary key and/or value field, which may delay processing of subsequent access requests, authenticator 128 attempts to insert the first primary key and corresponding value into table 1 32. If the storage operation terminates successfully, then this access request is the first access request within the time interval that is associated with the same address used to generate the first primary key. Authenticator 128 may then approve the access request. If an error is generated (e.g., a primary key exception, etc.), then authenticator 128 determines that the primary key already exists and that there has been at least one previous access request involving the same address used to generate the first primary key.

Authenticator 128 may then generate a second primary key and second value. The second primary key may include the address and the user profile identifier of the access request. The second value may be the same as the value associated with the first primary key, an indication of a quantity of times the second primary key is inserted into table 2 136 and/or any other information of the access request. If the second primary key and corresponding value are inserted into table 2 136 successfully, then authenticator 128 may execute a count query using table 2 136. The count query determines how many entries (primary keys, etc.) of table 1 132 and table 2 136 are associated with the same address as the access request. If the count query is greater than a threshold, then the address is associated with a malicious device attempting to gain authorized access to network 112 and/or resources of one or more user profiles managed by network 112. Authenticator 128 may deny the access request and prevent further access to network 112 by devices associated with the address.

If inserting the second primary key causes an error (e.g., such as a primary key exception, etc.), then the access request generated by user device 104 is likely legitimate. Authenticator 128 may update the timestamp (e.g., value corresponding to the second primary key, etc.) to make sure the second primary key remains in table 2 136. Authenticator 128 may approve the access request and the process may continue by processing the next access request.

Authenticator 128 may periodically clean table 1 132 and/or table 2 136 by removing entries that are older than the preceding time interval. Authenticator 128 may first clean table 2 136 by removing each entry (e.g., second primary keys, etc.) that is older than the preceding time interval. For each entry that is older than the preceding time interval, authenticator 128 may determine if there are any other entries in table 2 136 that are associated with the same second primary key such as any entry with the same address, user profile identifier, and/or any other information used to generate the second primary key. If no such entries exist, then authenticator 128 may search table 1 132 to determine if the entry associated with the second primary key in the table 1 32 (e.g., the entry corresponding to the first primary key associated with the same address, etc.) is older than the preceding time interval. If the entry associated with the first primary key is older than the preceding time interval, then authenticator 128 may remove the entry within the table 1 132.

In some examples, authentication system 124 may include one or more machine-learning models 140 configured to manage the processing access requests, identify patterns in access requests, identify fraudulent access request, trace access requests, identify malicious devices, combinations thereof, and/or the like. For example, machine-learning models 140 may be trained to define dynamic parameters of authenticator 128 such as, but not limited to, the threshold for the quantity of access requests associated with the same address that identifies fraudulent access requests, the preceding time interval, and/or the like. Machine-learning models 140 may also use pattern recognition to identify access requests that are irregular based on historical access requests associated with the same user device 104, client device 108, user profile identifiers, combinations thereof, and/or the like. Machine-learning models 140 may include a probabilistic classifier configured to classify access requests based on detect patterns. The machine-learning model may include, but is not limited to, Naïve Bayes, logistic regression models, perceptrons, support vector machine, random forest models, linear discriminant analyses models, k-nearest neighbor, k-means clustering algorithms, fuzzy c-means (FCM), expectation-maximization (EM), hierarchical clustering, density-based spatial clustering of applications with noise (DBSCAN), boosting, decision trees, combinations thereof, and/or the like. The machine-learning model may be trained using supervised learning, unsupervised learning, semi-supervised learning, transfer learning, metalearning, reinforcement learning, combinations thereof, or the like. The machine-learning model may be trained for a predetermined time interval, predetermined quantity of iterations, and/or until one or more accuracy metrics are reached (e.g., such as, but not limited to, accuracy, precision, area under the curve, logarithmic loss, F1 score, mean square error, or the like, combinations thereof, and/or the like).

In some examples, network 112 may access requests from messaging queue 120 in parallel with authentication system 124. In those instances, network 112 may authorize or deny access requests based on the information included in the access request and information associated with the user profile identified by the access request. Authentication system 124 may process the access requests before, during, or after network 112 process the access request. When processing access requests before or during the processing by network 112, authentication system 124 may cause a denial of the access request if authentication system 124 determines the access request is likely fraudulent. In addition, authentication system 124 may cause subsequent access requests associated with the same address, user profile identifier, source device (and/or user thereof), and/or the like to be denied preventing further access to the resources associated with the user profile by a malicious device. When processing access requests after network 112, authentication system 124 may not be able to deny an already authorized access request. Instead, authentication system 124 may cause subsequent access requests associated with the same address, user profile identifier, source device (and/or user thereof), and/or the like to be denied preventing further access to the resources associated with the user profile by a malicious device.

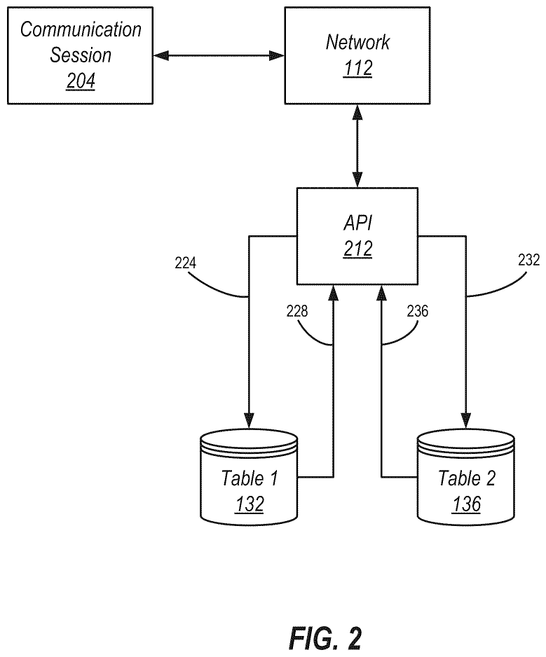

FIG. 2 illustrate an example interface configured to manage storage operations within databases tables according to aspects of the present disclosure. Communication session 204 may may be established between a user device (e.g., user device 104, etc.) and a client device (e.g., client device 108, etc.) to enable the user device to acquire objects and/or services provided by the client device and/or an agent thereof. In some instances, communication session 204 may be a web-based session (e.g., via Hypertext Transfer Protocol Secure (HTTPS), etc.) through a browser or web-based application, an application executing on the user device, combinations thereof, and/or the like. The user device may transmit access request information to the client device (or a device associated therewith) that enables the client device to access resources of the user device that are managed by a network (e.g., such as network 112, etc.). The client device may execute an access request for the resources. The access request may be processed by an authentication system to determine a likelihood that the access request is associated with a legitimate device or a malicious device (e.g., device impersonating a user and/or user device to gain unauthorized access to the resource and/or the network, etc.).

In some environments, network 112 may include an authentication system configured to authenticate access requests. In other environments, the authentication system may be configured to process access requests for one or more networks. The authentication system may expose one or more application programming interfaces (APIs 212) that provide access to functions of the authentication system that can be executed directly by network 112 (and/or any other network that the authentication system services). For instance, other networks (e.g., similar to network 112, or different therefrom) may access APIs 212 enable authentication of access request to the networks. In those environments, the authentication system may operate independently from each network. For example, the authentication system may include separate hardware components, separate environments, etc. that are accessible via API 212. In some instances, the authentication system may include one or more computing devices, servers, databases, cloud networks (or other distributed environments, etc.), combinations thereof, and/or the like.

The authentication system may use table 1 132 and table 2 136 (e.g., as previously described) to determine identify patterns in access request (e.g., such as when an address and/or user profile identifier appear in frequent access requests, etc.) and identify malicious devices. In some examples, the authentication system may use multiple instances of table 1 132 and table 2 136. For example, the authentication system may preserve privacy and security by isolating each instance of table 1 132 and table 2 136 based on the network that request authentication services. In those examples, when a network registers with the authentication system, the authentication system may instantiate an instance of table 1 132 and table 2 136 for that network. The authentication system may not search other instances of table 1 and table 2 when authenticating an access request. Alternatively, the authentication may search each instance of table 1 and table 2 when authenticating an access request to identify potential malicious devices and/or fraudulent access requests that are associated with multiple networks (e.g., access requests associated with a same address, but different user profiles managed by different networks, etc.).

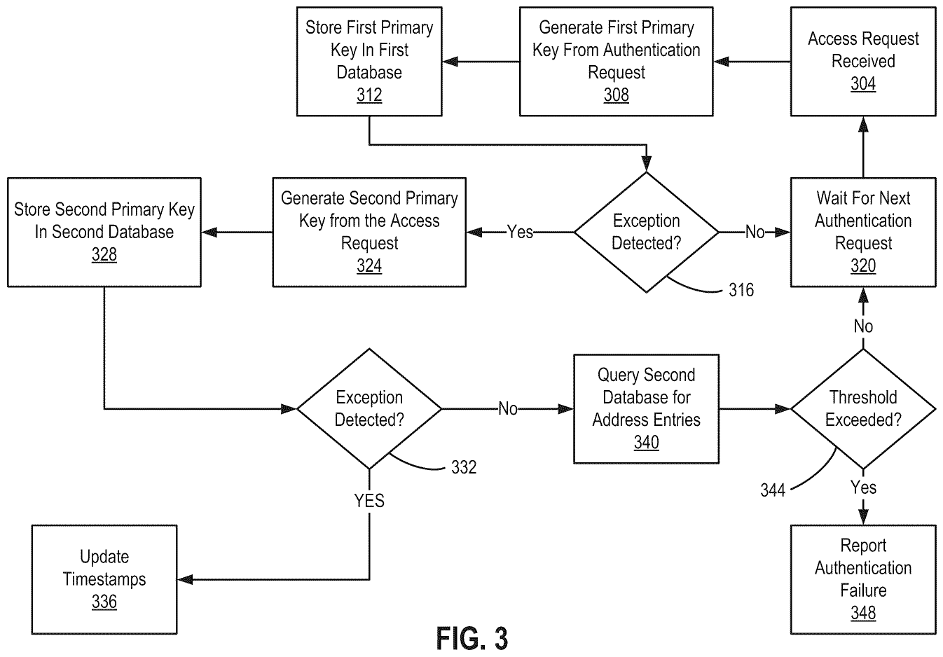

FIG. 3 illustrates an example flowchart to detect fraudulent access requests according to aspects of the present disclosure. A network may execute an authentication process to identify access requests that are likely facilitated by fraudulent devices. The process begins at block 304 when a new access request is received. The access request may be associated with a communication channel between a user device and a client device. For instance, a user device may connect to a client device via the communication channel to request access to objects and/or services. The user device may provide credentials to access a network that manages resources for the user device. The client device may then use the credentials to submit an access request for resources. The access request may include information associated with the user device and/or the client device such as, but not limited to, an address associated with the user device (e.g., a mailing address, IP address, MAC address, combinations thereof, and/or the like), an address associated with the client device (e.g., a mailing address, IP address, MAC address, combinations thereof, and/or the like), the credentials, a user profile identifier (e.g., an account identifier, etc. associated with a user profile of the network), an address corresponding to the user profile (e.g., mailing address, etc.), an identification of the user device and/or the user thereof, an identification of the client device and/or any users thereof, an identification of objects and/or services being request by the user device, an identification of a quantity of resources being request by the client devices, combinations thereof, and/or the like).

At block 308, the authentication system generates a first primary key from the access request. In some examples, the first primary key is generated using the address of the access request (e.g., the address associated with the device that facilitated the access request, etc.). In other examples, the first primary key may be generated using any information, or combination thereof, of the access request.

At block 312, the authentication system executes a storage operation to store the first primary key in a first database.

At block 316, the authentication system determines if the storage operation generated an error (e.g., such as a primary key exception or other database error as previously described). The first database may generate an error if the first primary key is already stored within the first database (e.g., the first primary key is a duplicate primary key, etc.). If the storage operation generates an error, then the process continues at block 320. If the storage operation does not generate an error, then the process continues at block 324.

At block 320 (when the storage operation does not generate an error), the authentication system may terminate processing of the authentication request and wait for the next authentication request to process. When a new authentication request is received, processing continues by returning to block 304. If the storage operation does not generate an error, then the authentication system determines that this is the first instance of the first primary key stored in the first database (e.g., first instance of this particular address being stored in the database).

At block 324 (when the storage operation generates an error), the authentication system generates a second primary key from the access request. The storage operation generating an error when attempting to store the first primary key is an indication that an instance of the first primary key (e.g., the address associated with the access request) is already stored within the firs database. In response, the authentication system generates a second primary key using the address and other information from the access request such as a user profile identifier (e.g., account identifier that identifies an account from which the resources managed by the network can be distributed). In some examples, the authentication system generates the second primary key by combining the address and the user profile identifier by, for example, concatenating the two values. In other instances, the address and the user profile identifier may be combined using other operations such as a bitwise combination, hashing, and/or any other operations.

At block 328, the authentication system executes a second storage operation to attempt to store the second primary key within a second database. In some examples, the first database and the second database may be a single database. Since the first database and the second database store unique primary keys and the second primary key is generated from additional information over the first primary key, it is possible to store the first primary key and the second primary key within the same database. In other examples, the first database and the second database may be different databases (e.g., occupying different regions in memory, etc.).

The storage operation may store the second primary key and a corresponding value associated with the access request. The second primary key may identify a location within the second database where the corresponding value is stored. In some examples, the value may be a timestamp corresponding to when the access request was generated or when the access request was received by the authentication system.

At block 332, the authentication system determines if the second storage operation generated an error (e.g., such as a primary key exception or other database error as previously described). The second database may generate an error if the second primary key is already stored within the second database (e.g., the second primary key is a duplicate primary key, etc.). If the storage operation generates an error, then the process continues at block 336. If the storage operation does not generate an error, then the process continues at block 340.

At block 336 (when the second storage operation generates an error), the authentication system updates the value stored in the second database that corresponds to the second primary key. For example, the value corresponding to the second primary key may be a timestamp corresponding to when the access request was generated or when the access request was received by the authentication system. The authentication system may use the timestamps to determine when a second primary key becomes too old (e.g., associated with an access request received more than a threshold time interval from a current time). The authentication may clean the second database by removing old second primary keys (and respective corresponding values) so that the second database stores information related to access requests that are recent (e.g., received less than the threshold time interval from the current time). The threshold time interval may be defined as n hours, where n is predetermined integer greater than zero. In some examples, n may be 2 hours such that the authentication system may remove second primary keys with a corresponding value that is greater than 2 hours. T

A duplicate second primary key causes the authentication system to update the value (e.g., timestamp, etc.) associated with the second primary key stored in the second database to prevent the second primary key from being removed from the second database. In some examples, the value corresponding to the second primary key may be updated to equal the timestamp associated with the current access request. In other instances, the value corresponding to the second primary key may be updated by resetting the timestamp to the current time.

At block 340 (when the second storage operation does not generate an error), the authentication system may execute a query of the second database for address entries. Since each second primary key includes two or more datapoints (e.g., the address and the user profile identifier, etc.), the presence or absence of an error during the storage operations may not indicate the quantity of second primary keys associated with same address or user profile alone. The authentication system may query the second database to determined how many second primary keys are associated with the same address (or user profile identifier). The query may return an integer value that indicates a quantity of access requests of the second database that are facilitated by the same address (or associated with a same user profile identifier). In some instances, the authentication system may increase the integer value by 1 to account for the address being present as the first primary key of the first database.

At block 344, the authentication system determines if the integer value exceeds a threshold. The authentication system may determine that too many access requests from the same address are likely the result of a malicious device attempting to gain access to the network and corresponding resources of one or more user profiles. The integer value may be defined by balancing the access rights of individual users with an impact to the network may a potential malicious device. The authentication system (or an administrator thereof) may increase the threshold or decrease the threshold. Increasing the threshold may reduce a likelihood of false positives when determining whether an address is associated with a malicious device but increase an impact that the malicious device may have on the network and the resources thereof. Decreasing the threshold may increase the likelihood of false positives when determining whether the address is associated with a malicious device but decrease the impact that the malicious device may have on the network and the resources thereof. In some examples, the threshold may be set of 4.

If the integer value is greater than the threshold, then the process continues at block 348. If the integer value is less than the threshold, then the process continues at block 320.

At block 348 (when the integer value is greater than the threshold), the authentication system may classify the access request as resulting from a malicious device. The authentication system may also classify the address as associated with fraud so that subsequent access requests associated with that address may be denied access to the network. For instance, if a subsequent access request is associated with the same address (regardless of the user profile), the authentication system may prevent access to the network. In some examples, the authentication system may transmit a communication to the client device or terminal device that transmitted the access request to the authentication system reporting the denial causing the client device and/or terminal device to terminate communications with the malicious device. In some examples, the authentication system may execute an alternative authentication process before allowing access requests associated with the address. For instance, the authentication system may request a token previously supplied to the device, execute a two-factor authentication, request one or more cryptographic keys, request a verbal authorization from a user, execute a TrustStamp verification, combinations thereof, and/or the like. If a device associated with the address passes the alternative authentication process, then the authentication system may enable process access requests associated with the address again. If the device associated with the address does not pass the alternative authentication process, then the authentication system may permanently block access requests from the address or block access requests from that address for a predetermined time interval (e.g., six months, one year, 5 years, etc.).

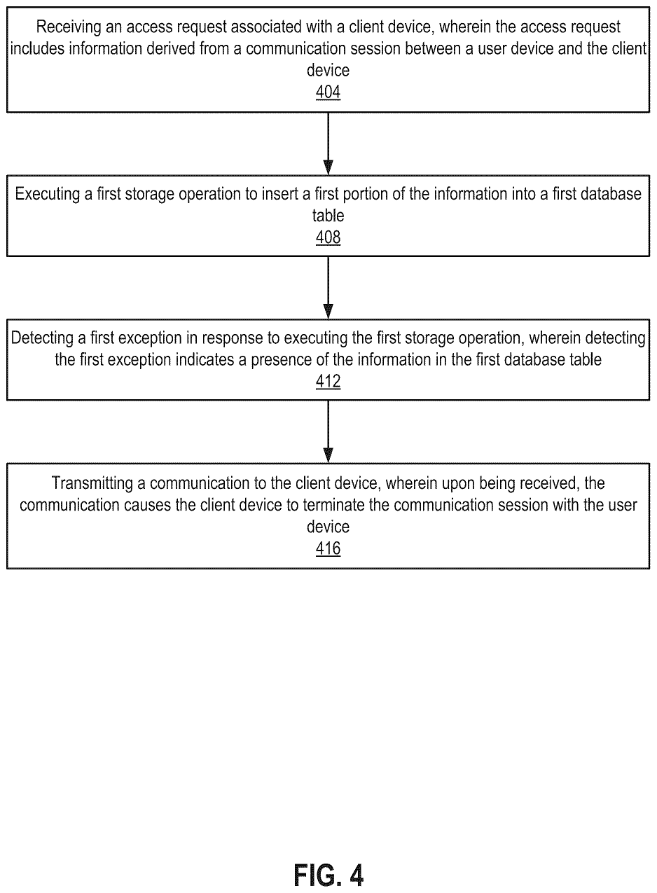

FIG. 4 illustrates a flowchart of an example process for authentication of access requests to secured resources according to aspects of the present disclosure. A malicious device may obtain credentials associated with various user devices enabling the malicious devices to impersonate the user devices and gain authorized access to the network and the resources managed by the network. The users of malicious devices know that once the unauthorized access to the network is detected (e.g., by the network and/or the user devices), the credentials may be deactivated or changed. As a result, malicious devices may generate many access requests to the network within short time interval to overwhelm the network's ability to detect the fraudulent access requests and maximize access to the resource before credentials are changed. The network may include an authentication system configured to identify patterns in access requests to prevent and/or limit unauthorized access to the network and the resources thereof.

For instance, at block 404, a computing device may receive an access request associated with a client device. In some examples, the computing device may be an authentication system (e.g., such as authentication system 124 of FIG. 1, etc.), a component of an authentication system, and/or a device that provides authentication services. The computing device may be configured to authenticate access requests to a network such as a network that manages resources for users. For instance, users may be provided with credentials (e.g., a token, a username and/or password, a physical access card, etc.) that provide access to resources of the network. A user device and/or the user thereof may establish a communication session with a client device (e.g., an entity that provides objects and/or services to users) and request objects and/or services. The user may transmit the credentials over the communication session to the client device (or a terminal device operated by the client device). The client device may generate an access request to the network (that is processed by the computing device) for resources for the objects and/or services requested by the user.

The access request may include a set of features derived from the communication session between a user device and the client device such as, but not limited to, access credentials, an address associated with the user device and/or the client device, a time stamp associated with the access request, a user profile identifier associated with a user profile management by the computing device, an identification of objects and/or services being requested, combinations therefore, and/or the like. The communication session may include real time communications (e.g., textual communications, voice communications, video communications, and/or the like) or asynchronous communications (e.g., non-real time, etc.). The communications may include natural language communications or data communications. In some examples, the communication session may be established over web-based interface such as a webpage, web application, text messaging (e.g., such as short messaging service, etc.), telephony, etc.). For instance, a user device may connect to a webpage operated by the client device.

In some examples, the computing device processes historical access requests to prevent future access to the resources of the network. In those examples, the access request received at block 404 may be an access request that has already been resolved by the network (e.g., granted or denied, etc.). The computing device may review the access requests to identify access requests that were likely associated with malicious devices and prevent subsequent access requests associated with the identified malicious devices and/or prevent subsequent access requests that appear similar to those access requests that were classified as associated with malicious devices. For example, the computing device may identify a group of access requests associated with a same address and classify those access requests being likely fraudulent. The computing device may then block future access requests associated with the address.

In other examples, the computing device may process current access requests before the access requests are resolved by the network. In those examples, each new access request may be reviewed by the computing device based on current and historical access requests to determine if the access request is authorized for processing by the network.

At block 408, the computing device may execute a first storage operation to insert a feature of the set of features (of the access request) into a first database table. The first database table may be a relational table (e.g., such as a RDBMS, etc.). The relational table may store data as key/value pairs where the key is referred to as a primary key. The primary key is unique and identifies a particular location within the first database table (e.g., such as a row within the first database table) that stores the corresponding value (or tuple, etc.). Since the primary key is intended to be unique, the first database table may not tolerate duplicate primary keys. Attempting to insert a duplicate primary key may cause the first database to generate an error (e.g., also sometimes referred to as a primary key integrity violation, primary key exception, duplication key exception, etc.).

The computing device may generate the primary key from the set of features derived from the communication channel. For instance, the computing device may generate the primary key using the address associated with the access request (e.g., the address of the user device, the address of the user thereof, the address associated with the user profile, combinations thereof, and/or the like). Alternatively, or additionally, the computing device may define the primary key using any of the set of features including, but not limited to, a timestamp associated with the access request (e.g., when the access request was generated and/or when the access request was received, etc.), a resource value requested by the access request, a user identifier, demographic information associated with the user, a transaction identifier, a random value, a token, a cryptographic key, a hash value, combinations thereof, and/or the like. The value to be stored in the database table corresponding to the primary key may include, but is not limited to, a timestamp associated with the access request (e.g., when the access request was generated and/or when the access request was received, etc.), a resource value requested by the access request, a user identifier, demographic information associated with the user, a transaction identifier, an identification of the client device, an address associated with the client device, a random value, a token, a cryptographic key, a hash value, a null value, any other features associated with the access request, combinations thereof, and/or the like.

The computing device may determine if the primary key has been stored in the first database table. The computing device may exploit the properties of the first database table to determine if the primary key has been stored in the first database without searching the first database table thereby saving the processing time and resources needed to execute such a search. For example, the computing device may attempt to store the primary key in the first database table. If the first storage operation terminates successfully (e.g., no errors are generated, etc.), then the computing device determines that this is the first instance of the primary key within the first database table and the first instance of an access request including the address (e.g., and/or the feature that was used to generate the primary key).

If the first storage operation causes an insertion error (e.g., such as any of the aforementioned errors), the computing device determines that this is not the first instances of the primary key within the first database table and not the first instance of an access request including the address (e.g., and/or the feature that was used to generate the primary key).

At block 412, the computing device detects a first exception in response to executing the first storage operation. Detecting the first exception indicates a presence of the feature in the first database table. For example, since the primary key is generated from an address of the user device, the first exception indicates that at least one previous access request was received that was associated with the same address. The computing device detecting a duplicate primary key may indicate that there are too many access requests from the same address. As a result, the computing device may determine that the address may associated with a malicious device. Upon identifying a potential malicious device, the computing device may prevent processing of future access requests from the address until the malicious device and/or another device associated with the address can be authenticated using an alternative authentication process. Preventing processing of subsequent access requests may prevent further fraudulent access to the resources.

At block 416, the computing device may transmit a communication to the client device in response to detecting the insertion error. The communication may be a denial of the access request, an identification of the first exception, combinations thereof, and/or the like. Receiving the communication may cause the client device to terminate the communication session with the user device.

In some examples, instead of performing the operations described in block 416, the computing device may continue processing the access request by defining a second primary key. In some examples, the second primary key may be defined using two or more features of the set of features. For instance, the second primary key may be defined from the address and a user profile identifier (e.g., an account identifier, etc.) of the user profile by, for example, concatenating the address and the user profile identifier, generating a hash value, and/or any other process for combining to data values. The two or more features may include, but not limited to, a user profile identifier, a timestamp associated with the access request (e.g., when the access request was generated and/or when the access request was received, etc.), a resource value requested by the access request, a user identifier, demographic information associated with the user, a transaction identifier, an identification of the client device, an address associated with the client device, a random value, a token, a cryptographic key, a hash value, any other feature associated with the access request, combinations thereof, and/or the like.

The value corresponding to the second primary key to be stored in the second database may include, but is not limited to, a number of storage operations executed using the second primary key (e.g. storage operations that executed successfully or generated errors, etc.), a timestamp associated with the access request (e.g., when the access request was generated and/or when the access request was received, etc.), a resource value requested by the access request, a user identifier, demographic information associated with the user, a transaction identifier, an identification of the client device, an address associated with the client device, a random value, a token, a cryptographic key, a hash value, a null value, any other feature associated with the access request, combinations thereof, and/or the like. For example, the value stored in association with the second primary key may be a timestamp associated with the most recent access request involving the same address and user profile identifier.

The computing device may execute a second storage operation to store the second primary key in a second database table. If the second storage operation terminates successfully (e.g., no errors are generated, etc.), then the computing device determines that this is the first instance of the second primary key within the second database table and the second access request involving the two or more features used to define the second primary key (e.g., the address of the access request and the user profile identifier). If the second storage operation causes an error (e.g., such as any of the aforementioned errors), then the computing device determines that this is not the first instance of the second primary key within the second database table and that there has been at least two previous access requests involving the feature of the primary key (e.g., the address of the primary key and the address of the second primary key, etc.).

If the second storage operation terminates successfully, the computing device may execute a count query to identify the number of entries in the second database table associated with a same address and/or user profile identifier. Since each second primary key is generated from a combination of two or more values, it may be possible for the second database table to store entries with the same address but different user profile identifiers and entries with the same user profile identifiers but different addresses, etc. The count query may return an integer value corresponding to how many entries in the second database table include the same address and/or user profile identifier.

If the integer value is greater than a threshold value (e.g., there are too many access requests associated with a same address within a time interval), than it is likely that the access requests associated the same address were facilitated by a malicious device attempting to access resources of one or more user profiles (from the same address). The computing device may transmit the communication to the client device in response to detecting that the integer value is greater than the threshold value. The communication may be a denial of the access request, an identification of the integer value being greater than the threshold value, an indication that subsequent access requests will be denied, a security violation message, combinations thereof, and/or the like. Receiving the communication may cause the client device to terminate the communication session with the user device. The computing device may deny further access to the network from the address (e.g., ensure that the access request of block 404 and/or subsequent access requests associated with the address or blocked) until the address can be authenticated using an alternative authentication process (e.g., telephone verification, physical mail, electronic mail, two-factor authentication, etc.)

The threshold value may be determined based on a quantity of acceptable access requests from a same address and/or user profile identifier within a time interval. The threshold value may be any integer value such as, but not limited to, 2, 3, 4, etc.). The threshold value may be defined based on the length of the time interval. The computing device may define (or adjust) the threshold value balancing the impact and access of devices generating access requests. In some examples, the threshold value may be dynamically defined based a rate of new access requests, historical access requests, a particular address, a particular user profile identifier, a particular user device and/or user, an average value of access requests, a value of a particular access requests, administrator input, a particular client device, combinations thereof, and/or the like. For example, the threshold value may be increased for user devices that historically generate multiple access requests within the time interval or decreased for user devices that historically generate few access requests within the time interval.

The time interval may be statically defined (e.g., predefined, etc.) or dynamically defined (e.g., defined and/or adjusted in real time). In some examples, the computing device may statically define the interval to be any real number such as, but not limited to, 30 minutes, 1 hour, 2 hours, etc. The computing device may dynamically define (or adjust) the time interval value based on one or more factors such as, but not limited to a rate of new access requests, historical access requests, a particular address, a particular user profile identifier, a particular user device and/or user, administrator input, an average value of access requests, a value of a particular access requests, a particular client device, combinations thereof, and/or the like. Like the threshold value, modifying the time interval may also increase or decrease an impact a potential malicious device may have on the network. For example, increasing the time interval may allow for more access requests before a malicious device is detected. Lowering the time interval may reduce the access requests before a malicious device is detected, but also increase a likelihood that legitimate access requests get denied (e.g., false positives, etc.).

If the second storage operation terminates unsuccessfully and results in an error, then the second primary key already exists within the second database table. The computing device may update the timestamp associated with the second primary key stored in the second database table to be the timestamp associated with the received access request at block 404. Updating the table ensures the second primary key remains in the second database table when the second database table is cleaned.

The first database table and/or the second database may be cleaned to ensure only the most recent access requests are processed by the computing device. The computing device may remove primary keys associated with timestamps older than the time interval. In some examples, the first database table and/or the second databases table may be cleaned in regular intervals based on the time interval such as, but not limited to every half hour, every hour, etc. In other examples, the computing device may clean the first database table and/or the second database table each time an access request is processed (and/or every n access requests where n is a predetermined positive integer).

In some instances, the second database table may be cleaned before the first database table. The computing device may determine if a second primary key of the second database table is older than the time interval and, if so, remove the second primary key from the second database table. The computing device may then determine for each second primary key removed, if the address associated with the second primary key exists within another second primary key. If the address associated with the second primary key exists within another second primary key, then the computing device moves on to the next second primary key being removed. If the address associated with the second primary key does not exist within another second primary key, then the computing device processes the primary key corresponding to that address in the first database table. If the primary key corresponding to that address in the first database table is older than the time interval, then the primary key is removed from the first database table and the cleaning process terminates. If the primary key corresponding to that address in the first database table is not older than the time interval, then computing device leaves the primary key in the first database table and the cleaning process terminates.

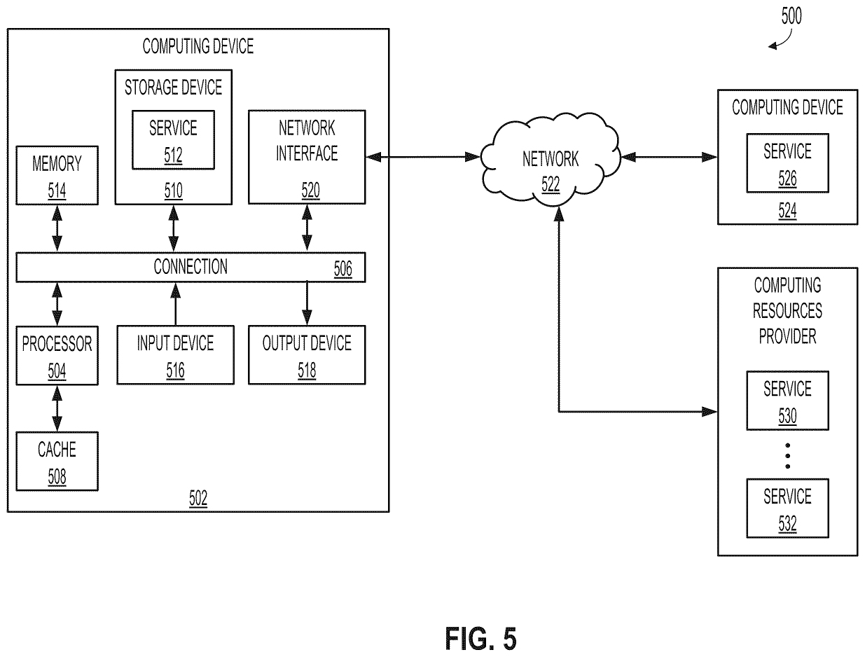

FIG. 5 illustrates a computing system architecture including various components in electrical communication with each other according to aspects of the present disclosure. The example computing system architecture 500 illustrated in FIG. 5 includes a computing device 502, which has various components in electrical communication with each other using a connection 506, such as a bus, in accordance with some implementations. The example computing system architecture 500 includes processor 504 that is in electrical communication with various system components, using the connection 506, and including the system memory 514. In some embodiments, the system memory 514 includes read-only memory (ROM), random-access memory (RAM), and other such memory technologies including, but not limited to, those described herein. In some embodiments, the example computing system architecture 500 includes a cache 508 of high-speed memory connected directly with, in close proximity to, or integrated as part of the processor 504. The system architecture 500 can copy data from the memory 514 and/or the storage device 510 to the cache 508 for quick access by the processor 504. In this way, the cache 508 can provide a performance boost that decreases or eliminates processor delays in the processor 504 due to waiting for data. Using modules, methods and services such as those described herein, the processor 504 can be configured to perform various actions. In some embodiments, the cache 508 may include multiple types of cache including, for example, level one (L1) and level two (L2) cache. The memory 514 may be referred to herein as system memory or computer system memory. The memory 514 may include, at various times, elements of an operating system, one or more applications, data associated with the operating system or the one or more applications, or other such data associated with the computing device 502.

Other system memory 514 can be available for use as well. The memory 514 can include multiple different types of memory with different performance characteristics. The processor 504 can include any general-purpose processor and one or more hardware or software services, such as service 512 stored in storage device 510, configured to control the processor 504 as well as a special-purpose processor where software instructions are incorporated into the actual processor design. The processor 504 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 504 can be a microprocessor, a microcontroller, a digital signal processor (“DSP”), or a combination of these and/or other types of processors. In some embodiments, the processor 504 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 500, an input device 516 can represent any number of input mechanisms, such as a microphone for speech, a touch-sensitive screen for gesture or graphical input, keyboard, mouse, motion input, pen, and other such input devices. An output device 518 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 500. In some embodiments, the input device 516 and/or the output device 518 can be coupled to the computing device 502 using a remote connection device such as, for example, a communication interface such as the network interface 520 described herein. In such embodiments, the communication interface can govern and manage the input and output received from the attached input device 516 and/or output device 518. As may be contemplated, there is no restriction on operating on any particular hardware arrangement and accordingly the basic features here may easily be substituted for other hardware, software, or firmware arrangements as they are developed.

In some embodiments, the storage device 510 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 510 can include hardware and/or software services such as service 512 that can control or configure the processor 504 to perform one or more functions including, but not limited to, the methods, processes, functions, systems, and services described herein in various embodiments. In some embodiments, the hardware or software services can be implemented as modules. As illustrated in example computing system architecture 500, the storage device 510 can be connected to other parts of the computing device 502 using the system connection 506. In some embodiments, a hardware service or hardware module such as service 512, that performs a function can include a software component stored in a non-transitory computer-readable medium that, in connection with the necessary hardware components, such as the processor 504, connection 506, cache 508, storage device 510, memory 514, input device 516, output device 518, and so forth, can carry out the functions such as those described herein.

The disclosed systems and services (e.g., the authentication of access requests as described in FIG. 4) can be performed using a computing system such as the example computing system illustrated in FIG. 5, using one or more components of the example computing system architecture 500. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some examples, the processor can be configured to carry out some or all of methods and systems described in connection with the authentication systems described herein by, for example, executing code using a processor such as processor 504 wherein the code is stored in memory such as memory 514 as described herein. One or more of a user device, a provider server or system, a database system, or other such devices, services, or systems may include some or all of the components of the computing system such as the example computing system illustrated in FIG. 5, using one or more components of the example computing system architecture 500 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital representative (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 528. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 504 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 514 can be coupled to the processor 504 by, for example, a connector such as connector 506, or a bus. As used herein, a connector or bus such as connector 506 is a communications system that transfers data between components within the computing device 502 and may, in some embodiments, be used to transfer data between computing devices. The connector 506 can be a data bus, a memory bus, a system bus, or other such data transfer mechanism. Examples of such connectors include, but are not limited to, an industry standard architecture (ISA“ bus, an extended ISA (EISA) bus, a parallel AT attachment (PATA” bus (e.g., an integrated drive electronics (IDE) or an extended IDE (EIDE) bus), or the various types of parallel component interconnect (PCI) buses (e.g., PCI, PCIe, PCI-104, etc.).

The memory 514 can include RAM including, but not limited to, dynamic RAM (DRAM), static RAM (SRAM), synchronous dynamic RAM (SDRAM), non-volatile random-access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 514 can also include magnetic or optical data storage media including read-only (e.g., CD ROM and DVD ROM) or otherwise (e.g., CD or DVD). The memory can be local, remote, or distributed.

As described above, the connector 506 (or bus) can also couple the processor 504 to the storage device 510, which may include non-volatile memory or storage, a drive unit, and/or the like. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 510. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 506 can also couple the processor 504 to a network interface device such as the network interface 520. The interface can include one or more of a modem or other such network interfaces including, but not limited to those described herein. It will be appreciated that the network interface 520 may be considered to be part of the computing device 502 or may be separate from the computing device 502. The network interface 520 can include one or more of an analog modem, Integrated Services Digital Network (ISDN) modem, cable modem, token ring interface, satellite transmission interface, or other interfaces for coupling a computer system to other computer systems. In some embodiments, the network interface 520 can include one or more input and/or output (I/O) devices. The I/O devices can include, by way of example but not limitation, input devices such as input device 516 and/or output devices such as output device 518. For example, the network interface 520 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™M operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSDTM and descendants, Xenix™M, SunOSTM, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 502 can be connected to one or more additional computing devices such as computing device 524 via a network 522 using a connection such as the network interface 520. In such embodiments, the computing device 524 may execute one or more services 526 to perform one or more functions under the control of, or on behalf of, programs and/or services operating on computing device 502. In some embodiments, a computing device such as computing device 524 may include one or more of the types of components as described in connection with computing device 502 including, but not limited to, a processor such as processor 504, a connection such as connection 506, a cache such as cache 508, a storage device such as storage device 510, memory such as memory 514, an input device such as input device 516, and an output device such as output device 518. In such embodiments, the computing device 524 can carry out the functions such as those described herein in connection with computing device 502. In some embodiments, the computing device 502 can be connected to a plurality of computing devices such as computing device 524, each of which may also be connected to a plurality of computing devices such as computing device 524. Such an embodiment may be referred to herein as a distributed computing environment.

The network 522 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 522 can be wired connections, wireless connections, or combinations thereof. Communications via the network 522 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 522, within the computing device 502, within the computing device 524, or within the computing resources provider 528 can include information, which also may be referred to herein as content. The information may include text, graphics, audio, video, haptics, and/or any other information that can be provided to a user of the computing device such as the computing device 502. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 502 and presented to a user of the computing device 502 using forms that are perceptible via sight, sound, smell, taste, touch, or other such mechanisms. In some embodiments, communications over the network 522 can be received and/or processed by a computing device configured as a server. Such communications can be sent and received using PHP: Hypertext Preprocessor (“PHP”), Python™M, Ruby, Perl® and variants, Java®, HTML, XML, or another such server-side processing language.

In some embodiments, the computing device 502 and/or the computing device 524 can be connected to a computing resources provider 528 via the network 522 using a network interface such as those described herein (e.g., network interface 520). In such embodiments, one or more systems (e.g., service 530 and service 532) hosted within the computing resources provider 528 (also referred to herein as within “a computing resources provider environment”) may execute one or more services to perform one or more functions under the control of, or on behalf of, programs and/or services operating on computing device 502 and/or computing device 524. Systems such as service 530 and service 532 may include one or more computing devices such as those described herein to execute computer code to perform the one or more functions under the control of, or on behalf of, programs and/or services operating on computing device 502 and/or computing device 524.

For example, the computing resources provider 528 may provide a service, operating on service 530 to store data for the computing device 502 when, for example, the amount of data that the computing device 502 exceeds the capacity of storage device 510. In another example, the computing resources provider 528 may provide a service to first instantiate a virtual machine (VM) on service 532, use that VM to access the data stored on service 532, perform one or more operations on that data, and provide a result of those one or more operations to the computing device 502. Such operations (e.g., data storage and VM instantiation) may be referred to herein as operating “in the cloud,” “within a cloud computing environment,” or “within a hosted virtual machine environment,” and the computing resources provider 528 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 528 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, combinations thereof, or the like. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 530 and service 532 may implement versions of various services (e.g., the service 512 or the service 526) on behalf of, or under the control of, computing device 502 and/or computing device 524. Such implemented versions of various services may involve one or more virtualization techniques so that, for example, it may appear to a user of computing device 502 that the service 512 is executing on the computing device 502 when the service is executing on, for example, service 530. As may also be contemplated, the various services operating within the computing resources provider 528 environment may be distributed among various systems within the environment as well as partially distributed onto computing device 524 and/or computing device 502.

The following examples illustrate various aspects of the present disclosure. As used below, any reference to a series of examples is to be understood as a reference to each of those examples disjunctively (e.g., “Examples 1-4” is to be understood as “Examples 1, 2, 4, or 4”).

Example 1 is a method comprising: receiving an authentication request associated with a client device, wherein the authentication request includes a set of features derived from a communication session between a user device and the client device; executing a first storage operation to insert a feature of the set of features into a first database table; detecting a first exception in response to executing the first storage operation, wherein detecting the first exception indicates a presence of the feature in the first database table; and transmitting a communication to the client device, wherein upon being received, the communication causes the client device to terminate the communication session with the user device.

Example 2 is the method of example(s) 1, wherein the first exception is a primary key exception.

Example 3 is the method of example(s) 1, wherein inserting the feature into the first database table includes inserting a key generated from the feature.

Example 4 is the method of example(s) 1, wherein the feature stored in the first database table is temporary, and wherein features stored in the first database table that are older than a threshold time interval are removed from the first database table.

Example 5 is the method of example(s) 1, wherein the feature includes an address associated with user device.

Example 6 is the method of example(s) 1, further comprising: executing a second storage operation in response to detecting the first exception, wherein the second storage operation inserts two or more features of the set of features into a second database table.

Example 7 is the method of example(s) 6, further comprising: detecting a second exception in response to executing the second storage operation; and updating a timestamp of an entry of the second database table that matches the two or more features.

Example 8 is the method of example(s) 6, further comprising: executing a query on the second database table using the feature to determine to identify a quantity of entries associated with the feature; and determining that the quantity of entries is greater than a threshold, wherein transmitting the communication to the client device is response to the quantity of entries being greater than the threshold.

Example 9 is the method of example(s) 6, wherein executing the second storage operation includes inserting a key generated from the two or more features.

Example 10 is the method of example(s) 6, wherein the two or more features include the feature.

Example 11 is the method of example(s) 6, wherein the two or more features include an address and a user profile identifier.

Example 12 is the method of example(s) 6, wherein information stored in the second database table is temporary, and wherein information stored in the second database table that is older than a threshold time interval is removed from the second database table.

Example 13 is a system comprising: one or more processors; and a non-transitory computer-readable medium storing instructions that when executed by the one or more processors, cause the one or more processors to perform the methods of any of example(s)s 1-12.

Example 14 is a non-transitory computer-readable medium storing instructions that when executed by one or more processors, cause the one or more processors to perform the methods of any of example(s)s 1-12.

Client devices, computing devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a keypad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 902) include, but is not limited to, desktop computers, laptop computers, server computers, hand-held computers, tablets, smart phones, personal digital representatives, digital home representatives, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein. [0001] Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process of FIG. 4). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general-purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital representative (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 602.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C} , namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claims.

1. A method comprising:
receiving an authentication request associated with a client device, wherein the authentication request includes a set of features derived from a communication session between a user device and the client device;
executing a first storage operation to insert a first dataset into a first database table, wherein the first dataset includes a first feature of the set of features;
detecting a primary key exception in response to executing the first storage operation, wherein detecting the primary key exception indicates a presence of the first feature in the first database table;
executing a second storage operation to insert a second dataset into a second database table, wherein the second dataset includes the first feature and at least one other feature of the set of features, wherein the first dataset is different from the second dataset, and wherein the second storage operation executes in response to detecting the primary key exception; and
transmitting a communication to the client device, wherein upon being received, the communication causes the client device to terminate the communication session with the user device.

2. (canceled)

3. The method of claim 1, wherein the first feature stored in the first database table is temporary, and wherein features stored in the first database table that are older than a threshold time interval are removed from the first database table.

4. The method of claim 1, wherein the first feature includes an address associated with user device.

5. (canceled)

6. The method of claim 1, further comprising:
detecting a second exception in response to executing the second storage operation; and
updating a timestamp of an entry of the second database table that matches the second dataset.

7. The method of claim 1, further comprising:
executing a query on the second database table using the first feature to identify a quantity of entries associated with the first feature; and
determining that the quantity of entries is greater than a threshold, wherein transmitting the communication to the client device is response to the quantity of entries being greater than the threshold.

8. A system comprising:
one or more processors; and
a non-transitory computer-readable medium storing instructions that when executed by the one or more processors, cause the one or more processors to perform operations including:
receiving an authentication request associated with a client device, wherein the authentication request includes a set of features derived from a communication session between a user device and the client device;
executing a first storage operation to insert a first dataset into a first database table, wherein the first dataset includes a first feature of the set of features;
detecting a primary key exception in response to executing the first storage operation, wherein detecting the primary key exception indicates a presence of the first feature in the first database table;
executing a second storage operation to insert a second dataset into a second database table, wherein the second dataset includes the first feature and at least one other feature of the set of features, wherein the first dataset is different from the second dataset, and wherein the second storage operation executes in response to detecting the primary key exception; and
transmitting a communication to the client device, wherein upon being received, the communication causes the client device to terminate the communication session with the user device.

9. (canceled)

10. The system of claim 8, wherein the first feature stored in the first database table is temporary, and wherein features stored in the first database table that are older than a threshold time interval are removed from the first database table.

11. The system of claim 8, wherein the first feature includes an address associated with user device.

12. (canceled)

13. The system of claim 8, wherein the operations further include:
detecting a second exception in response to executing the second storage operation; and
updating a timestamp of an entry of the second database table that matches the second dataset.

14. The system of claim 8, wherein the operations further include:
executing a query on the second database table using the first feature to identify a quantity of entries associated with the first feature; and
determining that the quantity of entries is greater than a threshold, wherein transmitting the communication to the client device is response to the quantity of entries being greater than the threshold.

15. A non-transitory computer-readable medium storing instructions that when executed by one or more processors, cause the one or more processors to perform operations including:
receiving an authentication request associated with a client device, wherein the authentication request includes a set of features derived from a communication session between a user device and the client device;
executing a first storage operation to insert a first dataset into a first database table, wherein the first dataset includes a first feature of the set of features;
detecting a primary key exception in response to executing the first storage operation, wherein detecting the primary key exception indicates a presence of the feature in the first database table;
executing a second storage operation to insert a second dataset into a second database table, wherein the second dataset includes the first feature and at least one other feature of the set of features, wherein the first dataset is different from the second dataset, and wherein the second storage operation executes in response to detecting the primary key exception feature; and
transmitting a communication to the client device, wherein upon being received, the communication causes the client device to terminate the communication session with the user device.

16. (canceled)

17. The non-transitory computer-readable medium of claim 15, wherein the first feature stored in the first database table is temporary, and wherein features stored in the first database table that are older than a threshold time interval are removed from the first database table.

18. (canceled)

19. The non-transitory computer-readable medium of claim 15, wherein the operations further include:
detecting a second exception in response to executing the second storage operation; and
updating a timestamp of an entry of the second database table that matches the second dataset.

20. The non-transitory computer-readable medium of claim 15, wherein the operations further include:
executing a query on the second database table using the first feature to identify a quantity of entries associated with the first feature; and
determining that the quantity of entries is greater than a threshold, wherein transmitting the communication to the client device is response to the quantity of entries being greater than the threshold.
